(19) United States
(12) Patent Application Publication
(10) Pub. No.: US 2016/0072141 A1
(43) Pub. Date: Mar. 10, 2016

(54) A WATER SEPARATOR

(71) Applicant: INTELLIGENT ENERGY LIMITED, Loughborough (GB)

(72) Inventors: Pratap Rama, Loughborough (GB); Jonathan Cole, Loughborough (GB)

(73) Assignee: Intelligent Energy Limited, Loughborough (GB)

(21) Appl. No.: 14/784,023

(22) PCT Filed: Apr. 24, 2014
(86) PCT No.: PCT/GB2014/051280

§ 371 Date: Oct. 12, 2015

(30) Foreign Application Priority Data
Apr. 24, 2013 (GB) 1307419.0

(51) Int. Cl. H01M 8/04; B01D 45/08

(52) U.S. Cl. CPC H01M 8/04291; B01D 45/08

(57) ABSTRACT

A liquid separator (100) comprising:
an inlet (102) configured to receive a fluid flow;
an outlet (104); and
a separation chamber (106) defining a fluid flow path between the inlet (102) and the outlet (104),
wherein the separation chamber (106) comprises an aerofoil (108) in the fluid flow path configured to separate liquid out of the fluid flow at regions of reduced fluid pressure.

The present disclosure relates to fuel cell systems and, in particular, to fuel cell systems that have a water separator at an exhaust of a fuel cell.

According to a first aspect of the invention there is provided a liquid separator comprising:
an inlet configured to receive a fluid flow;
an outlet; and
a separation chamber defining a fluid flow path between the inlet and the outlet,
wherein the separation chamber comprises an aerofoil in the fluid flow path configured to separate liquid out of the fluid flow at regions of reduced fluid pressure.

The aerofoil may be horizontally disposed in the separation chamber. A chord/camber line of the aerofoil may be disposed in the same plane as the fluid flow path in the separation chamber. The aerofoil may define a negative angle of attack.

The aerofoil may comprise a liquid communication surface comprising a liquid communication structure, which may be configured to direct separated liquid to a liquid exit region of the aerofoil. The liquid communication surface may be a lower surface of the aerofoil. The liquid communication structure may comprise one or more channels extending in the direction of the fluid flow path.

The liquid separator may further comprise a cooling means configured to cool the aerofoil. The cooling means may comprise a conduit passing through the aerofoil. The conduit may be configured to receive a coolant.

The liquid separator may further comprise a drain configured to communicate the separated liquid out of the separation chamber. The drain may be at a bottom wall of the separation chamber.

The liquid separator may further comprise an aerofoil angle setting mechanism configured to set the angle of attack of the aerofoil.

The liquid separator may comprise a plurality of aerofoils disposed in a longitudinally extending array relative to the flow path. The plurality of aerofoils may be each separated from one another by a longitudinal flow space.

The lateral width of the aerofoils may increase as a function of distance from the inlet. The longitudinal depth of the aerofoils may increase as a function of distance from the inlet. The longitudinal flow space of the aerofoils may decrease as a function of distance from the inlet. The angle of attack of the aerofoils may increase as a function of distance from the inlet.

The liquid separator may comprise a plurality of aerofoils disposed in a laterally extending array relative to the flow path.

The number of aerofoils in a lateral array of aerofoils may decrease as a function of distance from the inlet

The aerofoils in the laterally extending array may be:
spaced apart from one another in a first lateral dimension by a first lateral flow space; and/or
spaced apart from one another in a second lateral dimension by a second lateral flow space.

The width of the first lateral flow space between aerofoils may decrease as a function of distance from the inlet. The width of the second lateral flow space between aerofoils may decrease as a function of distance from the inlet.

The aerofoils in the laterally extending array may be spaced apart from one another by a radial lateral flow space. The width of the radial flow space between aerofoils may decrease as a function of distance from the inlet.

There may be provided a fuel cell system comprising:
a fuel cell having an exhaust; and
any liquid separator disclosed herein, wherein the inlet of the liquid separator is coupled to the exhaust of the fuel cell.

The exhaust of the fuel cell may be a cathode exhaust and/or a recirculated cathode exhaust. The exhaust of the fuel cell may be an anode exhaust and/or a recirculated anode exhaust.

A description is now given, by way of example only, with reference to the accompanying drawings, in which:

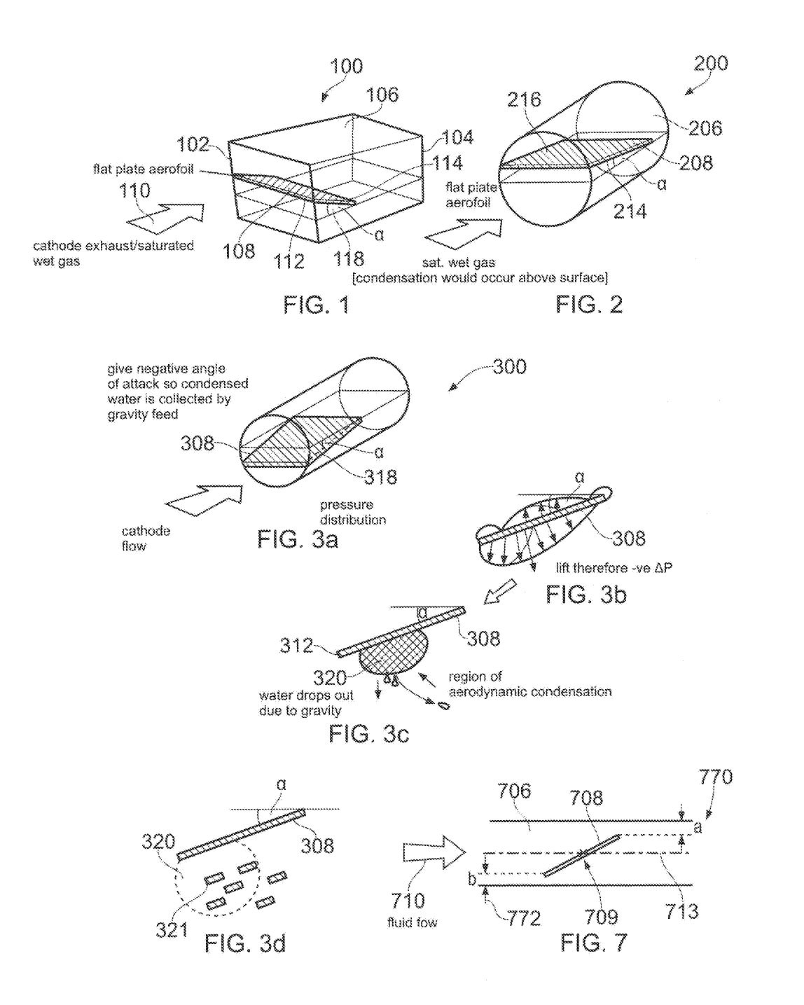

FIG. 1 illustrates a water separator;

FIG. 2 illustrates another water separator;

FIG. 3a illustrates a further still water separator;

FIG. 3b shows schematically the pressure differential of the fluid flow around an aerofoil of the water separator of FIG. 3a;

FIG. 3c shows a region of aerodynamic condensation on the aerofoil of FIG. 3b;

FIG. 3d shows a plurality of condensation structures in a region of aerodynamic condensation;

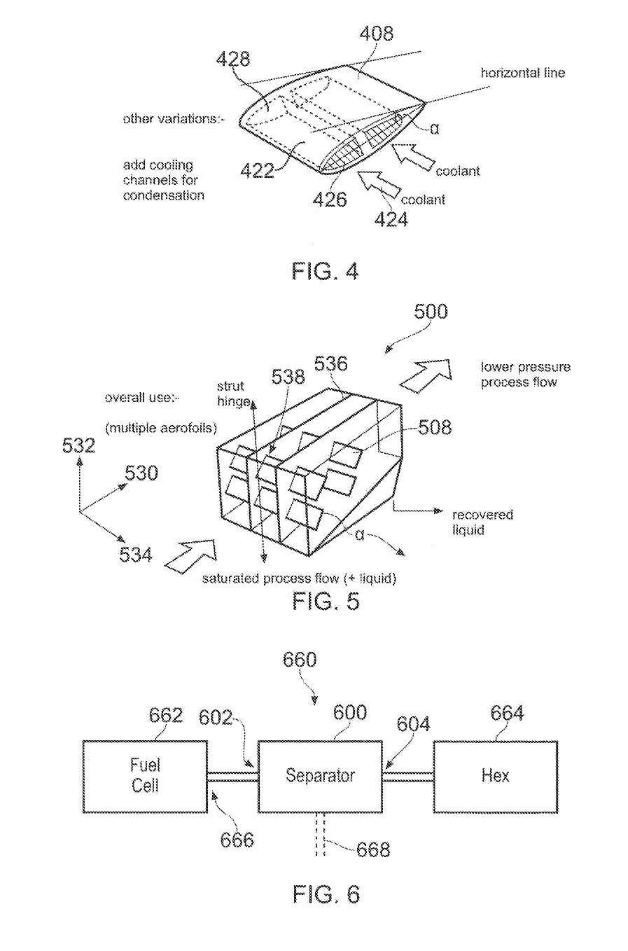

FIG. 4 illustrates an aerofoil for a water separator;

FIG. 5 illustrates a further water separator;

FIG. 6 illustrates a fuel cell system;

FIG. 7 illustrates another water separator;

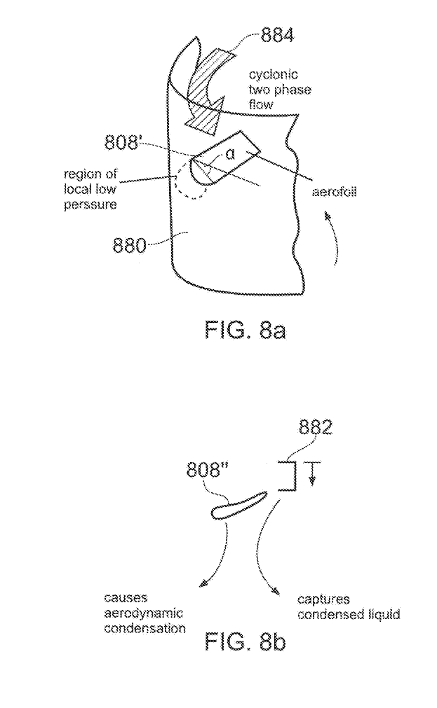

FIGS. 8a and 8b illustrate yet further water separators.

FIG. 1 illustrates a liquid separator 100 having an inlet 102 for receiving a fluid flow 110 such as an exhaust from a fuel cell, and an outlet 104. Located between the inlet 102 and the outlet 104 is a separation chamber 106 that defines a fluid flow path between the inlet 102 and the outlet 104. The separation chamber 106 may be an internal volume within a conduit/pipe that is used to transport the fluid flow 110.

The separation chamber 106 comprises an aerofoil 108 in the fluid flow path that is configured to separate liquid out of the fluid flow 110 at regions of reduced fluid pressure. The liquid separator 100 may be used to remove water from a cathode exhaust fluid, and therefore will be referred to as a water separator 100 in this disclosure. The skilled person will appreciate however that the liquid separator 100 can be used to separate any liquid from any fluid that it receives.

As is known in the art of aeronautics, an aerofoil 108 defines an angle of attack 118 with reference to a plane that is parallel to the direction of flow. This angle of attack 118 is given the symbol α. In the example of FIG. 1, the aerofoil 108 is horizontally disposed. The angle of attack α118 shown in FIG. 1 is a positive angle as the leading edge 112 of the aerofoil 108 is higher than the back edge 114.

The aerofoil 108 is mechanically constrained within the separation chamber 106, for example by having one or more of its tips secured to a wall of the separation chamber 106. The geometry of each aerofoil (span x depth) can be of the order of 1-100 mm, in some examples 10-100 mm.

The aerofoil 108 generates a pressure differential in the separation chamber 106 that causes aerodynamic condensation liquid water local condenses out of the received fluid flow. Assuming that this pressure difference arises adiabatically in the fluid flow (that is, positive or negative lift is generated without any gain or loss in heat), there will be a corresponding drop in temperature. This localised temperature drop (above the aerofoil 108 for a positive angle of attack and below the aerofoil 108 for a negative angle of attack) reduces the saturation vapour pressure, which causes water to condense out of the fluid flow.

The amount of aerodynamic condensation can be particularly significant for a saturated/partially saturated fluid flow that contains liquid water. For example, the fluid flow in the cathode exhaust of a fuel cell system can be saturated and can have a temperature of about 50° C.-95° C., depending on system current and backpressure. For such fluid flows, a small change in temperature can induce a notable change in vapour capacity hence a reasonable level of condensation of liquid water.

The aerofoil 108 will generate drag therefore resulting in a natural pressure drop locally across each aerofoil. In this example, the aerofoil 108 is generally planar, although it will be appreciated that in other examples, the shape of the aerofoil 108 can be designed to have any shape that provides the required pressure differential (and therefore amount of condensation) and an acceptable pressure drop that is experienced by the fluid flow as it passes through the liquid separator 100. In some examples, the pressure drop should be kept as low as possible, for example below a threshold value. In other examples a large pressure drop may be acceptable or even desirable.

An example of a published paper that describes how the pressure differential caused by an aerofoil can be calculated is: Gierens K, Karcher B, Mannstein H, Mayer B. Aerodynamic Contrails: Phenomenology and Flow Physics. Journal of Atmospheric Sciences, 66, 217-226, February 2009, DOI: 10.1175/2008JAS2767.1.

It has been found that both: i) increasing the angle of attack; and ii) increasing the flow velocity; increases the amount of pressure differential, thereby also increasing the amount of water separation. Therefore, the angle of attack α118 and the dimensions of the separation chamber 106 (that will control the flow velocity for a set flow rate) can be set to satisfy design requirements in terms of water separation and pressure drop across the water separator.

In the example of FIG. 1, the aerofoil 108 is located towards the front of the separation chamber 106. The separation chamber 106 may be considered as having a front region (proximal to the inlet 102) and a back region (distal to the inlet 102). The aerofoil 108 may be located in the front region, such that the back region defines a plenum beyond the back edge 114 of the aerofoil 108. Further details of how an aerofoil may be located in the separation chamber are provided below with reference to FIG. 7.

FIG. 2 illustrates a water separator 200 that is similar to the water separator of FIG. 1. In this example, the aerofoil 208 is provided in a conduit having a circular cross-section thereby defining a separation chamber 106 with a circular cross-section in a plane that is perpendicular to the fluid flow through the water separator 200. The aerofoil 208 may have side edges 214, 216 that are in contact with a wall of the separation chamber 206 along the entire depth of the aerofoil 208 (in a direction that is longitudinal to the direction of fluid flow through the separation chamber 206).

FIG. 3a illustrates a water separator 300 that is similar to the water separator of FIG. 2. In this example, the aerofoil 308 is provided with a negative angle of attack α318. Using a negative angle of attack α318 is advantageous in some examples as the water condenses on the lower surface of the aerofoil 308, thereby enabling the condensed liquid water to be removed from the aerofoil 308 by gravity. This can be convenient in some applications.

FIG. 3b shows schematically an example of the pressure differential of the fluid flow around the aerofoil 308. It will be appreciated that any specific distribution will depend on flow velocity, aerofoil profile and angle of attack principally. Since the aerofoil 308 has a negative angle of attack α, the lift provided by the aerofoil 308 is in a downward direction which causes a positive change in change in pressure below the aerofoil 308.

FIG. 3c shows that a region of aerodynamic condensation 320 that extends from the leading edge 312 of the aerofoil 308 on a lower surface of the aerofoil 308. The region of aerodynamic condensation 320 corresponds to some, or all, of the low pressure region of the local pressure differential across the aerofoil 308. In some examples, as shown in FIG. 3d, one or more condensation structures 321 can be provided in the region of aerodynamic condensation 320 such that liquid can condense out of the fluid flow in this region 320 onto the condensation structures 321. The condensation structures 321 can simply provide a surface that is located at a position that is expected to be within the low pressure region of the local pressure differential. Optionally, the condensation structures can be provided with a cooling means, such as a coolant loop similar to the one discussed above, to further encourage condensation.

The condensation structures can optionally be provided as structures that further assist in liquid separation through impingement separation.

In some examples, the aerodynamic condensation 320 can initially be a thin film of liquid water on the aerofoil 308 that grows over time until water droplets form that can drip off the aerofoil into the separation chamber under gravity.

In some examples a drain can be provided to communicate the separated water out of the separation chamber. The drain can be the outlet of the water separator such that a single outlet is provided for exhausting the gaseous fluid flow and the water that has been separated out of the fluid flow. In this way, the required capabilities of a downstream fluid processing component can be reduced. For example, the required duty of a subsequent heat exchanger can be reduced if some of the liquid water has been separated out of a fluid flow that is to be cooled.

In other examples, a separate drain port (not shown) can be provided in the separation chamber for communicating the separated water out of the separation chamber. The drain port can be located towards the bottom of the separation chamber, which is where the liquid water can be expected to accumulate under gravity. The drain port can be in a bottom wall that defines the separation chamber or can be in a side wall adjacent to the bottom wall. The dimensions of the drain port may be designed for a particular application to enable liquid water to pass out of the port but reduce the likelihood that gaseous fluid flow passes out of the drain port, which would be undesired.

The aerofoil 308 may have a liquid communication surface comprising a liquid communication structure (not shown in the drawings) such as one or more channels in a surface of the aerofoil 308. The liquid communication structure can be used to direct separated liquid to a liquid exit region of the aerofoil such as the lowermost edge of the aerofoil 308, which is the leading edge of the aerofoil 308 for the example of FIG. 3.

In the example of FIG. 3, the channels may be provided in a lower surface of the aerofoil 308 (as this is where condensation occurs). The one or more channels may extend in the direction of the fluid flow path, and/or in a direction that is transverse to the flow path if it is desirable for the separated water to exit the aerofoil 308 from a specific region or point in the lateral width of the aerofoil 308.

In other examples the liquid communication structure could be provided by one or more of ducts, guttering, or a material/structure that facilitates wicking of the separated water by capillary action.

FIG. 4 illustrates another aerofoil 408 that can be used with any water separator described herein. The top and bottom surfaces of the aerofoil 408 in this example are not planar as the aerofoil 408 has a thickness that varies along its depth, in particular it has a rounded leading edge and a trailing edge with a decreasing thickness as it extends away from the leading edge.

Also, the aerofoil 408 includes a cooling means for cooling the aerofoil 408. Such a cooling means can increase the amount of water that condenses out of the fluid flow on the aerofoil 408, thereby further improving the degree of water separation.

In this example, the cooling means is provided by passing coolant 424 through conduits 422 that pass through the aerofoil 408. It will be appreciated that any number of conduits 422 can be used. The conduits 422 define a coolant inlet 426 on a first side surface of the aerofoil 408 and a coolant outlet 428 on a second side surface of the aerofoil 408. The coolant inlets 426 may open into a coolant inlet manifold (not shown) for the associated water separator. Similarly, the coolant outlets 428 may open into a coolant outlet manifold (not shown). The coolant inlets 422 and coolant outlets 424 can be part of a coolant circuit/loop that is used to remove heat from the aerofoils 516.

For any specific application, the coolant inlet and/or outlet manifolds can be designed such that they do not significantly impede air flow though the water separator or water drainage from the water separator.

In addition to increasing the amount of condensation at the aerofoil 408, use of such a cooling means also reduces the temperature of the fluid that exits the water separator. This can be particularly beneficial for fuel cell systems that require the exhaust fluid to be cooled before it is vented to the environment; such systems conventionally use a heat exchanger to cool the exhaust fluid. The water separator may be provided instead of a conventional heat exchanger in a fuel cell system. In this way, the complexity, volume occupied and cost of the system can be greatly reduced as a single component can provide both water separation and exhaust heat reduction. Even if an additional heat exchanger is required, the thermal duty and physical size of such a heat exchanger can advantageously be (significantly) reduced.

The fluid that flows through the separation chamber from the inlet to the outlet can be considered as the hot fluid that flows through the heat exchanger and the coolant can be considered as the cold fluid that flows through the heat exchanger.

The number and arrangement of aerofoils within a separation chamber can be designed to meet specific requirements such as pressure drop constraints and liquid water recovery targets.

FIG. 5 illustrates a water separator 500 having a plurality of aerofoils 508. The aerofoils 508 are disposed in an array that extends longitudinally 530 relative to the flow path through the water separator 500, and also laterally relative to the flow path. The laterally extending array comprises aerofoils 508 that are spaced apart from one another in a first lateral dimension 532 by a first lateral flow space, and are also spaced apart from one another in a second lateral dimension 534 by a second lateral flow space. The aerofoils 508 in the longitudinally extending array are each separated from one another by a longitudinal flow space.

In the example of FIG. 5, vertically disposed walls are provided as struts 536 in the separation chamber. The struts 536 are provided in a plane that is parallel to the flow path through the separation chamber. Aerofoils 508 are attached to, or at least abut, each face of the struts 536, thereby defining a negligible second lateral flow space between adjacent aerofoils 508. It will be appreciated that in other examples a greater second lateral flow space can be provided by having aerofoils abutting only one face of a strut 536.

The aerofoils 508 of FIG. 5 are connected to the struts 536 by a hinge, thereby enabling the angle of attack α of each aerofoil to be set for a particular application. An aerofoil angle setting mechanism (not shown) can be provided to set the angle of attack of one or more of the aerofoils 508, for example as part of a calibration operation before the liquid separator is put into service. It will be appreciated that any of the water separators disclosed herein can be provided with an aerofoil angle setting mechanism.

An aerofoil angle setting mechanism can be useful in some applications to increase the backpressure when not used as an aerofoil to increase the pressure difference, and hence the temperature drop in the condensation zone.

One or more of the following parameters of the aerofoil array can be set in order to improve water separation for any particular application:
the span (lateral width) of the aerofoils, which may increase as a function of distance from the inlet;
the chord or camber length (longitudinal depth) of the aerofoils, which may increase as a function of distance from the inlet;
the longitudinal flow space of the aerofoils, which may decrease as a function of distance from the inlet;
the angle of attack of the aerofoils, which may increase as a function of distance from the inlet;
the width of the first flow space between aerofoils, which may decrease as a function of distance from the inlet;
the width of the second flow space between aerofoils, which may decrease as a function of distance from the inlet;
the number of aerofoils in a lateral array of aerofoils, which may decrease as a function of distance from the inlet;
the camber of the aerofoils, which may be designed for a particular application; and/or
the cross-sectional area of the inlet/upstream region relative to the aerofoil that is presented to the fluid flow in a plane that is perpendicular to the flow path through the water separator, which may decrease as a function of distance from the inlet.

In other examples, the laterally extending array of aerofoils 508 can be radially disposed such that the aerofoils are spaced apart from one another by a radial lateral flow space. In this way the aerofoils can take a form similar to that of a stator blade structure. The width of the radial flow space between aerofoils may decrease as a function of distance from the inlet.

Any of the above variations may be a monotonically increasing or decreasing function, or may be a more complex function.

In some examples, the aerofoil can be embedded into a conduit/separation chamber that is downstream of a blower or compressor. Similarly, aerofoils can be embedded where the fluid is being drawn by a compressor that is downstream of the aerofoil.

Optionally, if the geometry of the aerofoil is suitable, for example if it is large enough, a pump or other suction device can be provided in the low pressure region of the local pressure differential within the separation chamber in order to further decrease the pressure in this region, thereby increasing the pressure differential and causing more water to condense out of the received fluid flow. Such a suction device can advantageously also be used to remove separated water from the separation chamber, therefore also acting as a drain.

FIG. 6 illustrates a fuel cell system 660 that includes a fuel cell 662 and a water separator 600. The fuel cell 662 may comprise a single fuel cell or a fuel cell stack having a plurality of fuel cells. The fuel cell 662 has an exhaust 666 which is coupled to an inlet 602 of the water separator 600. The fuel cell exhaust 666 may be an anode or cathode exhaust of the fuel cell 102.

Also shown in FIG. 6 is an optional heat exchanger 664 that is coupled to an outlet 604 of the water separator 600. The heat exchanger 664 receives the outlet fluid from the water separator 600 and also any separated water, if the water separator 600 does not include a drain 668. As described above, use of a water separator 600 disclosed herein can reduce the requirements of the heat exchanger 664 thereby improving the fuel cell system 660.

FIG. 7 illustrates design parameters that can be considered when placing an aerofoil 708 in a separation chamber 706 in order to enable a local pressure drop across the aerofoil. Such a local pressure drop enables liquid to be condensed out of a received fluid flow 710. The aerofoil 708 defines a spacing (a) 770 between the trailing edge of the aerofoil 708 and the adjacent wall of the separation chamber 706. Similarly, the aerofoil 708 defines a spacing (b) 772 between the leading edge of the aerofoil 708 and the adjacent wall of the separation chamber 706. If the aerofoil 708 is pivoted 709 about the centre line 713 of the separation chamber (as shown in FIG. 7) then the aerofoil should be located in the separation chamber 706 such that (a) 770 does not equal (b) 772, otherwise the aerofoil 708 could act as a flow restrictor and may not generate a local pressure differential, which is required in order to function as an aerofoil.

In some examples the aerofoil 708 can be rotatably mounted within the separation chamber 708 instead of being fixedly mounted. In such examples the pivot can be located at a position that is off-centre of the aerofoil 708 or is off the centre line 713 of the separation chamber 706 in order to provide the required pressure differential across the aerofoil 708.

One or more of the liquid separators disclosed herein may be particularly advantageous for coupling to the cathode exhaust of an evaporatively cooled fuel cell 662, as such fuel cell systems 660 may benefit from being able to recover water from the cathode exhaust fluid so that the recovered water can be re-used. The liquid separators disclosed in this document may also be useful for separating liquid out of an exhaust from a liquid cooled fuel cell 662. The material of the aerofoil (all wetted parts) may be non-contaminating for some applications (such as when used in fuel cell systems) such that the quality of the fluids exposed to the aerofoil is maintained.

One or more of the water separators disclosed herein can be preferred to using a cyclone to induce a high speed swirling flow to separate fluids of different densities. In particular, one or more of the water separators described in this document can advantageously:
provide a low pressure drop between the inlet and the outlet;
reduce overall system volume as the water separator can be placed in the lines of existing system pipe work without taking up significant extra space;
reduce the likelihood that flow downstream of each aerofoil is turbulent, thereby reducing the noisiness of the fluid and reducing vibration
reduce the likelihood of universally-high pressure drops across the water separator; and/or
be easily scaled for different system requirements.

FIG. 8a illustrates an example of how a water separator as disclosed herein can be provided in a cyclone in order to improve water separation. An aerofoil 808′ is attached to an internal cyclone wall 880 such that cyclonic two-phase flow 884 passes over the aerofoil 808 in order to generate a region of local pressure differential and assist in water separation at the region of local low pressure.

FIG. 8b illustrates an example of how a water separator as disclosed herein can be used with an impingement water separator. An aerofoil 808″ is positioned upstream of an impingement channel 882 such that the aerofoil 808″ causes aerodynamic condensation and the downstream impingement channel 882 captures the condensed liquid.

It will be appreciated that one or more of the geometries of aerofoils disclosed in the document can be combined into a single aerofoil or combined in any arrangement in a an array of a plurality of aerofoils within a single water separator.

Any of the water separators disclosed herein can be located in the exhaust pipe work of the fuel cell, before or after a heat exchanger, and can be incorporated into conduits, flow channels and manifolds within devices such as cyclonic separators and heat exchangers.

The water separators disclosed in this document may be particularly well suited to construction by additive manufacturing or 3D printing.

Throughout the present specification, the descriptors relating to relative orientation and position, such as “top”, “bottom” and “side” as well as any adjective and adverb derivatives thereof, are used in the sense of the orientation of the fuel cell system as presented in the drawings. However, such descriptors are not intended to be in any way limiting to an intended use of the described or claimed invention.

1. A liquid separator comprising:
an inlet configured to receive a fluid flow;
an outlet; and
a separation chamber defining a fluid flow path between the inlet and the outlet,
wherein the separation chamber comprises an aerofoil in the fluid flow path configured to separate liquid out of the fluid flow at regions of reduced fluid pressure.

2. The liquid separator of claim 1, wherein the aerofoil is horizontally disposed in the separation chamber.

3. The liquid separator of claim 1, wherein the aerofoil defines a negative angle of attack.

4. The liquid separator of claim 1, wherein the aerofoil comprises a liquid communication surface comprising a liquid communication structure configured to direct separated liquid to a liquid exit region of the aerofoil.

5. The liquid separator of claim 4, wherein the liquid communication surface is a lower surface of the aerofoil.

6. The liquid separator of claim 4, wherein the liquid communication structure comprises one or more channels extending in the direction of the fluid flow path.

7. The liquid separator of claim 1, further comprising a cooling means configured to cool the aerofoil.

8. The liquid separator of claim 7, wherein the cooling means comprises a conduit passing through the aerofoil, the conduit configured to receive a coolant.

9. The liquid separator of claim 1, further comprising a drain configured to communicate the separated liquid out of the separation chamber.

10. The liquid separator of claim 9, wherein the drain is at a bottom wall of the separation chamber.

11. The liquid separator of claim 1, further comprising an aerofoil angle setting mechanism configured to set the angle of attack of the aerofoil.

12. The liquid separator of claim 1, comprising a plurality of aerofoils disposed in a longitudinally extending array relative to the flow path, wherein the plurality of aerofoils are each separated from one another by a longitudinal flow space.

13. The liquid separator of claim 12, wherein the span of the aerofoils increases as a function of distance from the inlet.

14. The liquid separator of claim 12, wherein the chord length of the aerofoils increases as a function of distance from the inlet.

15. The liquid separator of claim 12, wherein the longitudinal flow space of the aerofoils decreases as a function of distance from the inlet.

16. The liquid separator of claim 12, wherein the angle of attack of the aerofoils increases as a function of distance from the inlet.

17. The liquid separator of claim 1, comprising a plurality of aerofoils disposed in a laterally extending array relative to the flow path.

18. The liquid separator of claim 17, wherein the number of aerofoils in a lateral array of aerofoils decreases as a function of distance from the inlet

19. The liquid separator of claim 17, wherein the aerofoils in the laterally extending array are:
spaced apart from one another in a first lateral dimension by a first lateral flow space; and
spaced apart from one another in a second lateral dimension by a second lateral flow space.

20. The liquid separator of claim 19, wherein the width of the first lateral flow space between aerofoils decreases as a function of distance from the inlet.

21. The liquid separator of claim 19, wherein the width of the second lateral flow space between aerofoils decreases as a function of distance from the inlet.

22. The liquid separator of claim 17, wherein the aerofoils in the laterally extending array are spaced apart from one another by a radial lateral flow space.

23. The liquid separator of claim 22, wherein the width of the radial flow space between aerofoils decreases as a function of distance from the inlet.

24. A fuel cell system comprising:
a fuel cell having an exhaust; and
the liquid separator of claim 1, wherein the inlet of the liquid separator is coupled to the exhaust of the fuel cell.

25. The fuel cell system of claim 24, wherein the exhaust of the fuel cell is a cathode exhaust.

26-27. (canceled)
